(19) United States
(12) Patent Application Publication
(10) Pub. No.: US 2004/0233164 A1
(43) Pub. Date: Nov. 25, 2004

(54) Method and apparatus for displaying hardware crosshair cursor in a specified region of a display

(75) Inventors: Neal Richard Marion, Georgetown, TX (US); George Francis Ramsay III, Cedar Park, TX (US); James Stanley Tesauro, Austin, TX (US)

Correspondence Address: IBM CORP (YA), C/O YEE & ASSOCIATES PC, P.O. BOX 802333, DALLAS, TX, 75380, US

(73) Assignee: International Business Machines Corporation, Armonk, NY

(21) Appl. No.: 10/443,674

(22) Filed: May 22, 2003

(51) Int. Cl. G09G 5/08

(52) U.S. Cl. 345/157

(57) ABSTRACT

A method and apparatus for managing a hardware crosshair cursor function in a graphics adapter in a data processing system. A region, such as a window, is defined on a display using a set of coordinates. A hardware crosshair cursor is displayed only within the region by using the set of coordinates with the hardware crosshair cursor function in the graphics adapter.

### BACKGROUND OF THE INVENTION

1. Technical Field

The present invention relates generally to an improved data processing system and in particular, to a method and apparatus for processing data. Still more particularly, the present invention relates to a method and apparatus for displaying a cursor in a data processing system.

2. Description of Related Art

In data processing systems, graphical user interfaces (GUIs) are common interfaces for user interaction. Cursors are provided to allow a user to identify a point of focus on the screen of a data processing system. These cursors are controlled by a mouse. The term “mouse”, when used in this document, refers to any type of operating system supported graphical pointing device including, but not limited to: a mouse, track ball, touch pad, light pin, touch screen, and the like. A pointing device is typically employed by a user of the data processing system to interact with the data processing system's GUI. A “cursor” is an iconic image controlled by a mouse or other such device, and is displayed on the video display device of a data processing system to visually indicate to the user icons, menus, or other types of graphical objects that may be selected or manipulated.

One cursor that is presently available is a hardware crosshair cursor. A hardware crosshair cursor is a hardware implementation of a cursor, which is formed by two perpendicular lines that span the full width and height of the screen. When the pointing device is moved in an X direction, the vertical line in the hardware cursor is moved. When the pointing device is moved in a Y direction, the horizontal line in the cursor is moved. This hardware implementation for a hardware crosshair cursor is typically found in a random access memory digital to analog converter (RAMDAC) chip in a graphics adapter.

Some applications, such as computer aided design (CAD) applications, use a crosshair cursor. If the graphics adapter supports a hardware crosshair cursor, the applications may either implement the crosshair cursor in software or use the hardware crosshair cursor in the graphics adapter. Implementation of a crosshair cursor in software results in performance degradation because the application has to manage the cursor by updating the frame buffer when the crosshair cursor is moved. Use of a hardware crosshair cursor by an application improves performance because the application does not have to redraw the frame buffer when the pointing device is moved.

One problem with using a hardware crosshair cursor is that this type of cursor function is provided as a full screen cursor. If an application wants to display a hardware crosshair cursor in a window and not in a full screen manner, the application must implement the crosshair cursor in software. As mentioned above, this implementation involves redrawing the frame buffer every time the pointing device moves, resulting in degraded performance and increased complexity in the application.

Therefore, it would be advantageous to have an improved method, apparatus, and computer instructions for implementing a crosshair cursor for use in a window or some selected area of the screen without the problems involved with a software implementation.

### SUMMARY OF THE INVENTION

The present invention provides a method and apparatus for managing a hardware crosshair cursor function in a graphics adapter in a data processing system. A region, such as a window, is defined on a display using a set of coordinates. These coordinates are stored in a register in the graphics adapter. A hardware crosshair cursor is displayed only within the region by using the set of coordinates with the hardware crosshair cursor function in the graphics adapter.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram illustrating a data processing system in which the present invention may be implemented;

FIG. 3 is a block diagram illustrating a graphics adapter in accordance with a preferred embodiment of the present invention;

FIG. 4 is a diagram of components used in displaying a hardware crosshair cursor within a region in accordance with a preferred embodiment of the present invention;

FIG. 5 is a flowchart of a process for a hardware crosshair cursor function in accordance with a preferred embodiment of the present invention;

FIG. 6 is a flowchart of a process for handling movement of a hardware crosshair cursor in accordance with a preferred embodiment of the present invention; and

FIG. 7 is a flowchart of a process for resetting a hardware crosshair cursor region in accordance with a preferred embodiment of the present invention.

### DETAILED DESCRIPTION OF THE PREFERRED EMBODIMENT

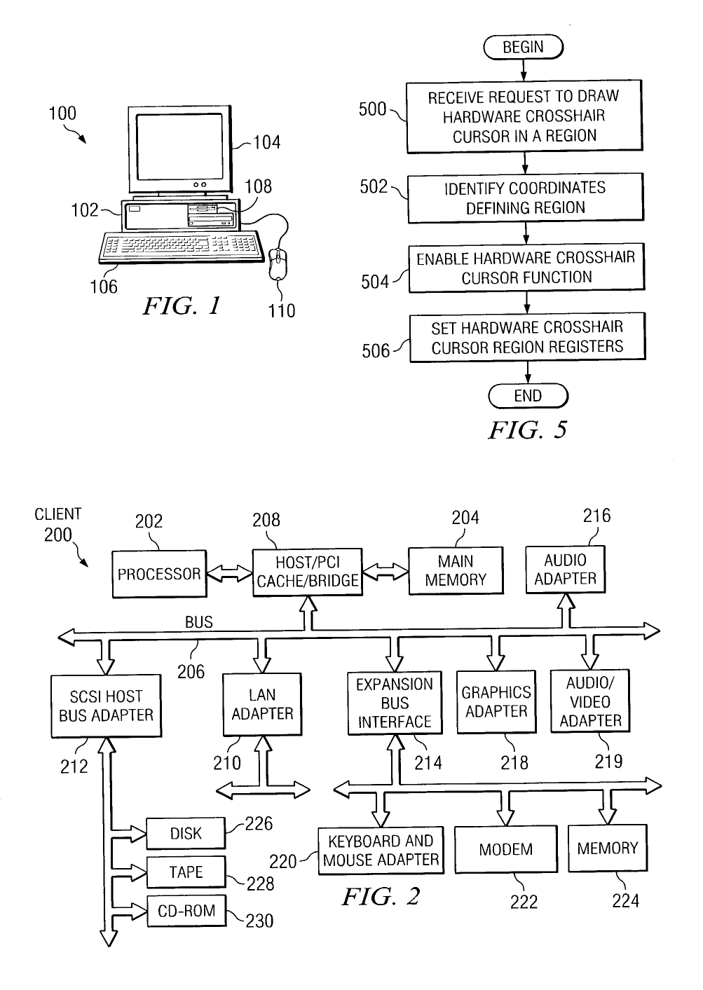

With reference now to the figures and in particular with reference to FIG. 1, a pictorial representation of a data processing system in which the present invention may be implemented is depicted in accordance with a preferred embodiment of the present invention. A computer 100 is depicted which includes a system unit 102, a video display terminal 104, a keyboard 106, storage devices 108, which may include floppy drives and other types of permanent and removable storage media, and mouse 110. Additional input devices may be included with personal computer 100. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface that may be implemented by means of systems software residing in computer readable media in operation within computer 100.

With reference now to FIG. 2, a block diagram illustrates a data processing system in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. The processes of the present invention may be used to manage rendering of data by graphics adapter 218 or audio/video adapter 219.

Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. Instructions for the operating system and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a Personal Digital Assistant (PDA) device which is configured with ROM and/or flash ROM in order to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

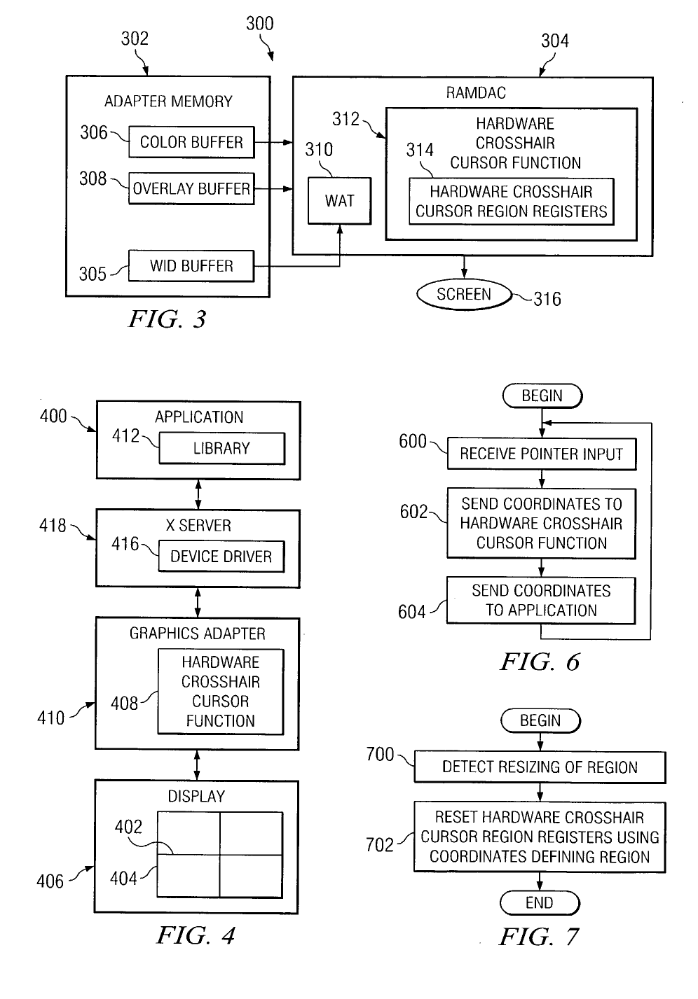

Turning next to FIG. 3, a block diagram illustrating a graphics adapter is depicted in accordance with a preferred embodiment of the present invention. Graphics adapter 300 is an example of a graphics adapter, such as graphics adapter 218 in FIG. 2.

In this example, graphics adapter 300 includes an adapter memory 302 and a random access memory digital to analog converter (RAMDAC) 304. Adapter memory 302 contains window ID (WID) buffer 305, color frame buffer 306, and overlay frame buffer 308. RAMDAC 304 includes window attribute table (WAT) table 310 and hardware crosshair cursor function 312, which includes hardware crosshair cursor region registers 314. The two frame buffers, color frame buffer 306 and overlay frame buffer 308, contain pixels, which are sent to RAMDAC 304 for output to a display device, such as screen 316. RAMDAC 304 is a graphics controller chip that provides a hardware crosshair cursor for display on screen 316 through hardware crosshair cursor function 312.

In these examples, hardware crosshair cursor region registers 314 are employed to store coordinates defining a region in which the hardware crosshair cursor is to be displayed. Hardware crosshair cursor function 312 allows an application to set the location and extent of a hardware crosshair cursor using hardware crosshair cursor region registers 314. As a result, the hardware crosshair cursor is not visible outside of the defined region. In these examples, hardware crosshair cursor region registers 314 may include two sets of X and Y coordinates. A first set of X and Y coordinates defines the minimum extents of the region, and the second set of X and Y coordinates defines the maximum extents of the region. This region is typically that of a window. Hardware crosshair cursor region registers 314 also include a register that is employed to enable the hardware crosshair function.

Turning now to FIG. 4, a diagram of components used in displaying a hardware crosshair cursor within a region is depicted in accordance with a preferred embodiment of the present invention. In this example, application 400 may display crosshair cursor 402 within region 404 of display 406. In this example, region 404 is a window. Such a cursor may be displayed using a hardware function, rather than a software implementation through the use of hardware crosshair cursor function 408 in graphics adapter 410. Hardware crosshair cursor function 408 may be located within a RAMDAC. For example, in FIG. 3, hardware crosshair cursor function 312 is found within RAMDAC 304. Of course, this function could be implemented in other hardware depending on the particular implementation.

In this example, application 400 may define the region for window 404, by using library 412 to make a call to device driver 416 in Xserver 418, which is a UNIX based windowing system. Of course, the mechanism of the present invention may be implemented with any operating system. The call made by library 412 sends a pair of X and Y coordinates used to define the region for window 404. Device driver 416 receives this set of coordinates and sets the appropriate registers within hardware crosshair cursor function 408. In this manner, cursor 402 is displayed only within region 404.

Movement of crosshair cursor 402 is handled by Xserver 418. Movements of crosshair cursor 402 are detected when a pointing device associated with crosshair cursor 402. In these examples, the movements are handled by the operating system, which may report these movements to application 400. If region 404 is resized, this information is sent to application 400 by Xserver 418. With resizing of region 404, application 400 makes another call using library 412 to redefine the region for hardware crosshair cursor function 408.

Consequently, performance is enhanced because the frame buffer in graphics adapter 410 does not have to be updated every time crosshair cursor 402 is moved. Further, complexity of application 400 is moved because this cursor function is provided through adapter 410, rather than requiring a software implementation.

Turning now to FIG. 5, a flowchart of a process for a hardware crosshair cursor function is depicted in accordance with a preferred embodiment of the present invention. The process illustrated in FIG. 5 is implemented in a device driver, such as device driver 416 in FIG. 4.

The process begins by receiving a request to draw a hardware cursor in a region (step 500). In these examples, the request is received from an application, such as application 400 in FIG. 4. Thereafter, coordinates defining the region are identified (step 502). The hardware crosshair cursor function is enabled (step 504). A register is set in the RAMDAC to enable the crosshair cursor. Thereafter, the hardware crosshair cursor region registers are set with the identified coordinates identifying the region (step 506), with the process terminating thereafter.

With reference now to FIG. 6, a flowchart of a process for handling movement of a hardware crosshair cursor is depicted in accordance with a preferred embodiment of the present invention. The process illustrated in FIG. 6 may be implemented in an operating system, such as Xserver 418 in FIG. 4.

The process begins by receiving pointer input (step 600). The pointer input is received in response to movement of the pointing device by the user. This pointer input identifies new coordinates for the cursor. Next, these coordinates are sent to the hardware crosshair cursor function (step 602). The coordinates are sent to hardware crosshair cursor function to allow the function to update the display of the crosshair cursor.

Coordinates also are sent to the application (step 604), with the process then returning to step 600 to receive additional pointer input. These coordinates are sent to the application to allow the application to process the input. The application may use the coordinates to identify the location of the cursor in the window. The location could be used draw lines, rectangles, rotate 3D models, select regions etc.

In FIG. 7, a flowchart of a process for resetting a hardware crosshair cursor region is depicted in accordance with a preferred embodiment of the present invention. The process illustrated in FIG. 7 may be implemented by an application, such as application 400 in FIG. 4.

The process begins by detecting resizing of the region (step 700). The application may detect resizing of the region through information sent to the application by the operating system. For example, user input selecting an appropriate portion of a window, coordinate changes, and a release of the portion of the window after the coordinate changes may indicate that the window has been resized. In response, the hardware crosshair cursor region registers are reset using new coordinates defining the resized region (step 702) with the process terminating thereafter.

The coordinates reset by step 702 may be performed using a library call originated by the application to the device driver. In response, the device driver resets the coordinates in the registers for the hardware crosshair cursor function. Alternatively, the detecting of resizing and resetting of the region may be performed by a different component, such as the operating system, depending on the particular implementation.

Thus, the present invention provides an improved method, apparatus, and computer instructions for displaying a crosshair cursor using a hardware crosshair cursor function. This mechanism allows an application to set the location and the region of the crosshair cursor. Registers are provided in the hardware, such as in a RAMDAC to set the extents of the region. In this manner, the hardware crosshair cursor function may display the hardware crosshair cursor only within the region. The hardware crosshair cursor is not visible outside of this region using the mechanism of the present invention. As a result, application performance is increased by not requiring a software implementation for this type of cursor. Further, the complexity of the application is reduced because this function is implemented in hardware.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for managing a hardware crosshair cursor function in a graphics adapter, the method comprising:
defining a region on a display using a set of coordinates; and
displaying a hardware crosshair cursor only within the region by using the set of coordinates with the hardware crosshair cursor function.

2. The method of claim 1, wherein the region is a window for an application.

3. The method of claim 1 further comprising:
storing the set of coordinates in a set of registers within a graphics adapter containing the hardware crosshair cursor function.

4. The method of claim 1, wherein screen coordinates are two pairs of X and Y coordinates.

5. The method of claim 1, wherein the screen coordinates include a minimum X value, a minimum Y value, a maximum X value, and a maximum Y value.

6. The method of claim 3, wherein the set of registers is set by an application displaying a window in the region.

7. An application embodied in a computer readable medium as computer instructions, wherein the application comprises:
a first set of instructions for defining a region using coordinates; and
a second set of instructions, responsive to execution of the first set of instruction, for sending the coordinates to a hardware crosshair cursor function, wherein the coordinates are used by the hardware crosshair cursor function to display a hardware crosshair cursor only within the region.

8. The application of claim 7, wherein the region is a window.

9. The application of claim 7 further comprising:
a third set of instructions for reinitiating the first set of instructions in response to a change in at least one of a size of the region and a location of the region.

10. A random access memory digital to analog converter comprising:
a set of registers, wherein the set of registers stores screen coordinates defining a region; and
a hardware crosshair cursor function, wherein the screen coordinates are used by the hardware crosshair cursor function to display a hardware crosshair cursor only within the region.

11. The random access memory digital to analog converter of claim 10, wherein screen coordinates are two pairs of X and Y coordinates.

12. The random access memory digital to analog converter of claim 10, wherein the screen coordinates include a minimum X value, a minimum Y value, a maximum X value, and a maximum Y value.

13. The random access memory digital to analog converter of claim 10, wherein the set of registers is set by an application displaying a window in the region.

14. The random access memory digital to analog converter of claim 13, wherein the application sets the register by making a call to a device driver associated with the random access memory digital to analog converter.

15. A data processing system for managing a hardware crosshair cursor function in a graphics adapter, the data processing system comprising:
defining means for defining a region on a display using a set of coordinates; and
displaying means for displaying a hardware crosshair cursor only within the region by using the set of coordinates with the hardware crosshair cursor function.

16. The data processing system of claim 15, wherein the region is a window for an application.

17. The data processing system of claim 15 further comprising:
storing means for storing the set of coordinates in a set of registers within a graphics adapter containing the hardware crosshair cursor function.

18. The data processing system of claim 15, wherein screen coordinates are two pairs of x and y coordinates.

19. The data processing system of claim 15, wherein the screen coordinates include a minimum X value, a minimum Y value, a maximum X value, and a maximum Y value.

20. The data processing system of claim of claim 17, wherein the register is set by an application displaying a window in the region.
